(19) United States
(12) Patent Application Publication
(10) Pub. No.: US 2008/0083488 A1
(43) Pub. Date: Apr. 10, 2008

(54) Surfboard, Kiteboard, and Other Floatation Devices Manufacturing Process

(76) Inventor: Jorg Warmuth, Birmingham, AL (US)

Correspondence Address: QUICKPATENTS, INC., 32861 CALLE PERFECTO, SUITE A, SAN JUAN CAPISTRANO, CA, 92675, US

(21) Appl. No.: 11/539,490

(22) Filed: Oct. 6, 2006

(51) Int. Cl. B29C 44/20

(52) U.S. Cl. 156/256; 264/45.9; 264/51; 264/148; 264/129; 156/78

(57) ABSTRACT

A method of manufacturing a blank for a floatation device is disclosed. Polystyrene material is introduced into an extruder and heated. The molten polystyrene is then blown with carbon dioxide to form a polystyrene foam that is extruded into a sizing tunnel to create a desired cross-section for a floatation device blank. The carbon dioxide pressure is preset to provide a resulting polystyrene foam having desired rigidity and density characteristics, and other softening agents may be used to achieve desired rigidity and density characteristics. The extruded polystyrene foam is then cut into blocks of predetermined length, which are then cut and shaped into a desired floatation device blank that may be finished as with conventional blanks.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to manufacturing of floatation devices, and more particularly to a novel method of using CO₂ as a foaming agent for extruded polystyrene.

### DISCUSSION OF RELATED ART

Currently used processes used to produce floatation devices such as surfboards, kiteboards, or the like, have either undesirable rigidity and density characteristics, size limitations, moisture absorption characteristics, or environmental impact. Many of these prior-art processes utilize CFCs (chlorofluorocarbons), HCFCs (hydro-chlorofluorocarbons), VOCs (volatile organic compounds), and other ozone-depleting agents.

For example, with prior art devices that utilize polyurethane foams, very little rigidity and density variation can be obtained due to constraints of the chemical formulation of the foam. Expanded Polystyrene (EPS, or Styrofoam), on the other hand, which does allow for varied rigidity and density characteristics, typically includes pentane as a blowing agent, resulting in undesirable rigidity and narrow density variation. Even the latest technologies that use extruded polystyrene use HCFCs, CFCs, or VOCs, which soften the rigidity of the polystyrene material yet which are environmentally undesirable. Furthermore, waste produced by many such prior art processes cannot be recycled and must be discarded, further taxing the environment.

Size flexibility is another drawback of the prior art devices that utilize a molding process as opposed to an extruding process. It is not economical or practical to produce a mold for a single blank. As such, the variety of such floatation devices is limited in sizes and shapes by the number of molds available to the manufacturer.

Other surfboard blank foam manufacturing processes result in a blank that absorbs an inordinate amount of moisture, either over a period of time or in the case when an outer finishing resin is punctured or otherwise damaged to allow moisture into the floatation device.

Overall, surfboard blanks have been made for many years out of wood, polyurethane foam, expanded Styrofoam, and even extruded Styrofoam. With the exception of the wood products, which have their own drawbacks, all such processes utilize to some extent CFCs, HCFCs, VOCs, or other ozone-depleting environmentally damaging substances. Moreover, polyester resin is often used to finish such products, which is also damaging to the environment.

Therefore, there is a need for a floatation device manufacturing processes that utilizes extruded polystyrene blown with a blowing agent that is not only environmentally friendly, but results in desirable flexibility in terms of setting the rigidity and density of the final product. Such a needed process would allow scrap and waste material to be easily recycled, and would be relatively easy to shape, cut, and otherwise form. Such a needed process would further allow additional additives to be introduced, in minimal amounts, to further adjust the desired rigidity and density of the product, and would also not be unduly limited as to the size of the blanks produced. Still further, such a needed process would result in a floatation device that is not susceptible to moisture absorption, and can be finished with epoxy resin or other resins that do not damage the underlying blank. The present invention accomplishes these objectives.

### SUMMARY OF THE INVENTION

The present invention is a method of manufacturing a blank for a floatation device, such as a surfboard, a kiteboard, or the like. Such blanks are typically formed after manufacturing into the floatation device, such as by cutting, carving, sanding and like operations.

In the simplest embodiment of the invention, polystyrene is introduced into an extruder and heated. The molten polystyrene is then blown with carbon dioxide to form a polystyrene foam that is extruded into a sizing tunnel to create a desired cross-section for a floatation device blank. The carbon dioxide pressure is preset to provide a resulting polystyrene foam having desired rigidity and density characteristics. The extruded polystyrene foam is then cut into blocks of predetermined length. Such blocks are then cut and shaped into a desired floatation device blank that may be finished as with conventional blanks.

In the case where a surfboard is the floatation device, each floatation device blank preferably represents one-half of the surfboard, and a stringer formed from a rigid material is formed with two opposing planar sides. Each floatation device blank half is cut and shaped with at least one planar side for adhering to either sides of the stringer.

The blanks, at this point, may be finished or sold to another finisher as desired. Finishing includes the steps of applying a coating of epoxy resin to seal the blank and to increase board strength. Further, glass or carbon fibers may also be applied to the blank with a mixture of resin to retain the fibers to the blank.

The present invention is a floatation device manufacturing process that utilizes extruded polystyrene blown with carbon dioxide, a blowing agent that is not only environmentally friendly, but results in desirable flexibility in terms of being able to predetermine the rigidity and density of the final product. The present method allows scrap and waste material to be easily recycled, and results in a floatation device blank that is relatively easy to shape, cut, and otherwise form. Further, the inventive method allows additional additives to be introduced, in minimal amounts, to further adjust the desired rigidity and density of the product, and is not unduly limited as to the size of the blanks produced, as with molded products. Still further, the current process results in a floatation device that is not susceptible to moisture absorption, and can be finished with environmentally-friendlier epoxy resin without damaging the underlying blank. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a process flow diagram of the most general embodiment of the method of the present invention; and

FIG. 2 is an exploded perspective view of a pair of surfboard blanks, joined at a stringer, and made using the method of the present invention.

### DETAILED DESCRIPTION OF THE PREFERRED EMBODIMENT

The present invention is a method of manufacturing a blank 40 for a floatation device 10, such as a surfboard, a kiteboard, or the like (FIG. 2). Such blanks 40 are typically formed into the floatation device 10 after manufacturing, such as by cutting, carving, sanding and like operations. Such blanks 40 are conventionally made by molding polystyrene, which limited the size of the resulting floatation devices 10. Those floatation device blanks 40 made by extruding other materials conventionally use chloroflourocarbons, hydro-chlorofluorocarbons, volatile organic compounds, and other ozone-depleting substances as blowing agents. In the present invention, these environmentally harmful blowing agents are replaced with carbon dioxide.

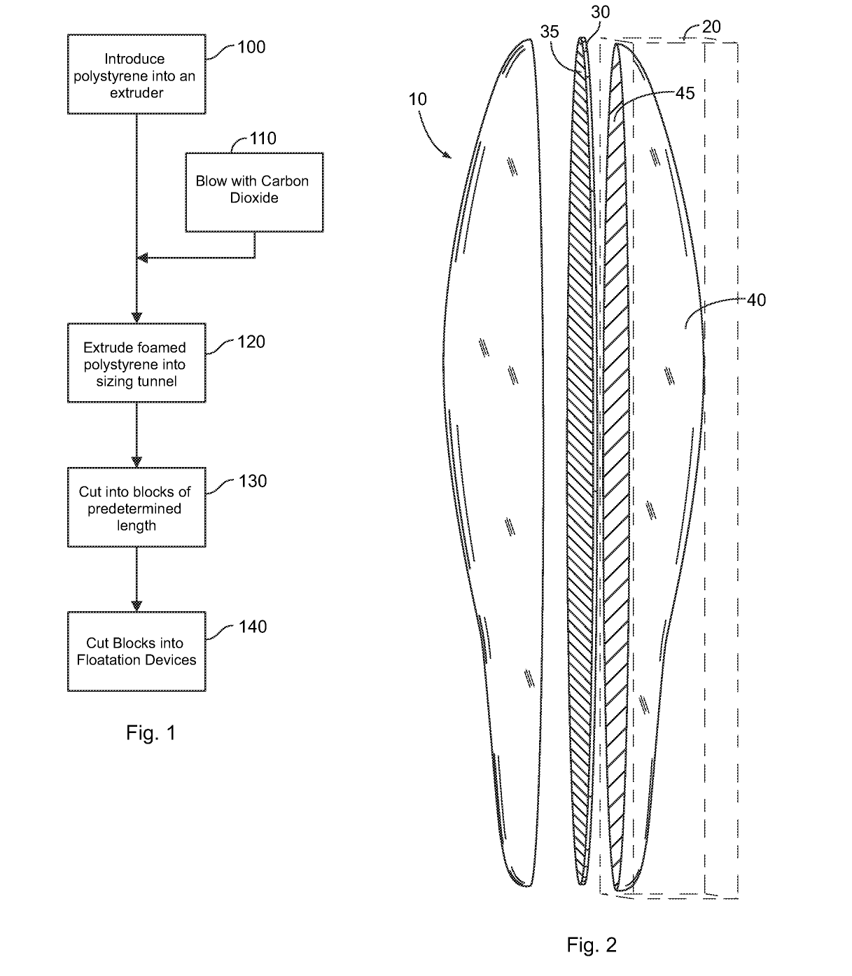

In the simplest embodiment of the invention, as diagramed in FIG. 1, polystyrene material is introduced into an extruder, as designated by step number 100, and heated. The molten polystyrene is then blown with carbon dioxide, designated as step 110, to form a polystyrene foam that is extruded into a sizing tunnel, designated as step 120, to create a desired cross-section for a floatation device blank 40. The carbon dioxide pressure is preset to provide a resulting polystyrene foam having desired rigidity and density characteristics, typically 550 to 650 bar. Changing the pressure of the carbon dioxide blowing agent, as well as secondary additives, results in changes to the rigidity and density of the resulting foam blanks. For example, a small amount of butane, such as less than 2.4% or the like, may be introduced to slightly soften the resulting rigidity of the extruded foam material. Other additives may be introduced to likewise alter the rigidity and density characteristics of the resulting foam.

The extruded polystyrene foam is then cut into blocks 20 of predetermined length, designated as step 130. Such blocks 20 are then cut and shaped, designated as step 140, into a desired floatation device blank 40 that may be finished as with conventional blanks 40, preferably with CNC (computer numeric control) cutting tools for precision cutting. Other cutting methods, such as by blade cutting, hot wire cutting, water-jet cutting, routing, shearing and the like may be used, with or without CNC guidance.

In the case where a surfboard 10 is the floatation device 10, each floatation device blank 40 preferably represents one-half of the surfboard 10, and a stringer 30 formed from a rigid material, such as wood, a rigid plastic material, or the like, is formed with two opposing planar sides 35. Each floatation device blank 40 half is cut and shaped with at least one planar side 45 for adhering to either sides of the stringer 30. Clearly such a stringer 30 may be precut before the floatation device blanks 40 are made or after. Further, such stringers 30 may be cut with CNC-controlled cutting equipment so as to create a precisely matched fit with each foam blank 40 half.

The blank 40, at this point, may be finished or sold to another finisher as desired. Finishing includes the steps of applying a coating of epoxy resin to seal the blank 40 and to increase board strength. Further, glass or carbon fibers may also be applied to the blank with a mixture of resin to retain the fibers to the blank (not shown).

Advantageously, scrap and waste polystyrene foam generated when making the blanks 40 produced by the current method may be reintroduced into the extrusion process 100 in order to be recycled. As such, very little waste is generated from the present manufacturing method, further aiding in maintaining the environment.

While a particular form of the invention has been illustrated and described, it will be apparent that various modifications can be made without departing from the spirit and scope of the invention. For example, the exact type of floatation device being made may be varied. Accordingly, it is not intended that the invention be limited, except as by the appended claims.

What is claimed is:

1. A method of manufacturing a floatation device, comprising the steps of:
a) introducing polystyrene into an extruder;
b) blowing the polystyrene with carbon dioxide to create a polystyrene foam;
c) extruding the polystyrene foam into a sizing tunnel to create a desired cross-sectional shape;
d) cutting the extruded polystyrene foam into a block of a predetermined length; and
e) cutting the block into the floatation device.

2. A method of manufacturing a floatation device, comprising the steps of:
a) introducing polystyrene into an extruder;
b) blowing the polystyrene with carbon dioxide to create a polystyrene foam;
c) extruding the polystyrene foam into a sizing tunnel to create a desired cross-sectional shape;
d) cutting the extruded polystyrene foam into at least two blocks of a predetermined length;
e) cutting each block into one-half of a floatation device blank, at least one edge of each block being generally planar;
f) cutting a stringer from a rigid material, at least two sides of which are planar and generally parallel; and
g) adhering both floatation device blank halves onto the opposing planar sides of the stringer to create the flotation device blank.

3. The method of claim 2 wherein step f) is performed before step a).

4. The method of claim 2 wherein step f) is performed before step e).

5. The method of claim 2 wherein step b) is blowing the polystyrene with carbon dioxide at a predetermined pressure to create a polystyrene foam having predetermined rigidity and density characteristics.

6. The method of claim 2 wherein step b) is blowing the polystyrene with a mixture of carbon dioxide and a volatile organic compound to create a polystyrene foam having predetermined rigidity and density characteristics.

7. The method of claim 2 wherein step b) is blowing the polystyrene with a mixture of carbon dioxide and a non-volatile organic compound to create a polystyrene foam having predetermined rigidity and density characteristics.

8. The method of claim 2 wherein step d) is cutting the extruded polystyrene foam, using CNC equipment, into at least two blocks of a predetermined length.

9. The method of claim 2 wherein step e) is cutting each block into one-half of a floatation device blank, using CNC cutting equipment, at least one edge of each block being generally planar.

10. The method of claim 2 wherein step f) is cutting a stringer from a rigid material, using CNC equipment, at least two sides of the stringer being generally planar and parallel.

11. The method of claim 2 further including the step of h) finishing the floatation device blank by applying a coating of epoxy resin thereto.

12. The method of claim 2 further including the step of h) finishing the floatation device blank by applying a coating of epoxy resin and glass fiber thereto.

13. The method of claim 2 further including the step of h) finishing the floatation device blank by applying a coating of epoxy resin and carbon fiber thereto.
